(19) United States
(12) Patent Application Publication
(10) Pub. No.: US 2015/0353190 A1
(43) Pub. Date: Dec. 10, 2015

(54) METHOD FOR MANAGING THE BRAKING OF AN AIRCRAFT WHEEL

(71) Applicant: MESSIER-BUGATTI-DOWTY, Velizy Villacoublay (FR)

(72) Inventors: Sylvain JABER, Velizy Villacoublay (FR); Raffi CEKIC, Velizy Villacoublay (FR)

(73) Assignee: MESSIER-BUGATTI-DOWTY, Velizy Villacoublay (FR)

(21) Appl. No.: 14/722,453

(22) Filed: May 27, 2015

(30) Foreign Application Priority Data
Jun. 6, 2014 (FR) 14 55182

(51) Int. Cl. B64C 25/42; B60T 8/171; B60T 8/1761

(52) U.S. Cl. CPC B64C 25/42; B60T 8/17616; B60T 8/171

(57) ABSTRACT

Method for managing the braking of a wheel (4) of an aircraft (1) fitted with a brake (11), the aircraft comprising brake control means suited to implementing an anti-skid function of the wheel (4), requiring an estimate of a rotational speed of the wheel, the aircraft further comprising means of driving the wheel including an electric motor (6) intended to drive the wheel (4) in rotation, the said electric motor (6) being fitted with a position sensor (8) intended to provide measurements of the angular position of a rotor of the motor (6). The method comprises the step, for implementing the anti-skid function, of estimating the rotational speed of the wheel (4) from measurements of the angular position of the rotor which are supplied by the position sensor (8).

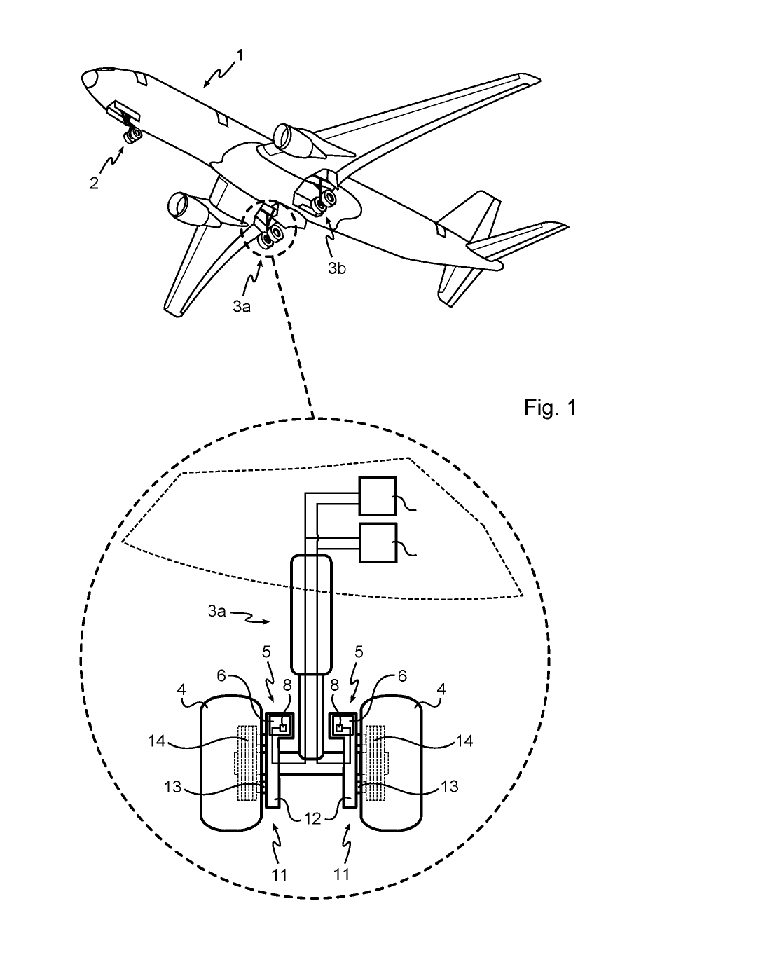

The invention relates to a method for managing the braking of an aircraft wheel, the said wheel being associated with means for driving the wheel in rotation including an electric motor.

### BACKGROUND OF THE INVENTION

There are a number of reasons that are encouraging aircraft manufacturers to attempt to motorize aircraft wheels, notably using drive actuators fitted with electric motors. Such motorization indeed offers significant environmental and economic advantages (by reducing fuel consumption, reducing noise during taxiing etc.), and allows novel functions to be achieved: allowing the aircraft to be manoeuvred when the propulsion engines are switched off, running in reverse, steering the aircraft along the ground remotely etc.

The increase in aircraft mass resulting from the incorporation of the drive actuators needs to be controlled and reasonable so as not to make the benefit in terms of fuel consumption afforded by the use of these actuators negligible. Now, the rotational speeds at which the wheels of the aircraft need to be driven and the torques that the drive actuators need to develop are great and require heavy and bulky actuators.

### OBJECT OF THE INVENTION

It is an object of the invention to reduce the mass of an aircraft with motorized wheels.

### SUMMARY OF THE INVENTION

In order to achieve this object, there is proposed a method for managing the braking of a wheel of an aircraft fitted with a brake, the aircraft comprising brake control means suited to implementing a function of preventing the wheel from skidding, requiring an estimate of a rotational speed of the wheel, the aircraft further comprising means of driving the wheel including an electric motor intended to drive the wheel in rotation, the said electric motor being fitted with a position sensor intended to provide measurements of the angular position of a rotor of the motor. According to the invention, the method comprises the step, for implementing the anti-skid function, of estimating the rotational speed of the wheel from measurements of the angular position of the rotor which are supplied by the position sensor.

The reduction in aircraft mass is therefore obtained by sharing the use of the position sensor of the electric motor of the wheel driving means. Rather than using a tachymeter dedicated to the anti-skid function, the electric motor position sensor is used to perform this function. The braking management method of the invention therefore makes it possible to reduce the number of equipment items and cables incorporated into the various systems associated with aircraft landing gear. This then reduces the impact that the use of drive means has on the mass of these systems and therefore on that of the aircraft. It may be noted that this solution also makes it possible to improve the accuracy of the anti-skid function because the electric motor rotor position sensors are markedly more precise than the tachymeters traditionally used for performing the anti-skid function.

### BRIEF DESCRIPTION OF THE DRAWINGS

The invention will be better understood in the light of the description which follows with reference to the attached figure which depicts an aircraft and a detailed view of the aircraft showing a main landing gear bearing two braked wheels on which the braking management method of the invention is implemented.

### DETAILLED DESCRIPTION OF THE INVENTION

With reference to the single figure, the invention is implemented here on an aircraft 1 comprising an auxiliary landing gear 2 and two main landing gears 3a, 3b.

The invention is described with reference solely to the main landing gear 3a because the entire description can be applied to the other main landing gear 3b.

The main landing gear 3a is fitted with two wheels 4. Means 5 for driving the rotation of the wheels 4 are installed on the main landing gears 3a. These drive means 5, depicted schematically in the figure, comprise, for each wheel 4, a drive actuator comprising an electric motor 6 intended to drive the wheel 4 in rotation.

The electric motors 6 are synchronous permanent magnet electric motors. The electric motors 6 are controlled by a control computer 7 associated with the two wheels 4 of the main landing gear 3a. The control computer 7 notably contains, for each electric motor 6, a self-regulated voltage inverter the operation of which entails knowledge, at each moment, of the position of a rotor of the electric motor 6. Each electric motor 6 for this purpose comprises a position sensor 8 connected to the control computer 7 and intended to supply the control computer 7 with measurements of the angular position of the rotor of the electric motor 6. This position sensor 8 is, in this instance, a resolver incorporated directly into the electric motor 6.

It must be emphasized that, in the figure, only the electrical connections connecting the position sensors 8 have been depicted, to make the depiction of the main landing gear 3a simpler.

In order to brake the aircraft 1, each wheel 4 of the main landing gear 3a is fitted here with an electromechanical brake 11 comprising a ring 12, electromechanical actuators 13 borne by the ring 12, and a stack of carbon discs 14 consisting of rotors that rotate as one with a rim of the wheel 4 and of stators that rotate as one with a torsion tube of the wheel 4. The electromechanical actuators 13 are designed selectively to apply a braking force to the stack of discs 14 in order to slow the rotation of the rim of the wheel 4 and therefore brake the aircraft 1.

The braking of the aircraft 1 is controlled by control means here comprising a braking computer 16 associated with the two wheels 4 of the main landing gear 3a. The braking computer 16 is connected to two control units (not depicted in the figure) which are connected to the electromechanical actuators 13 of one and the same wheel 4 and convert a braking setpoint supplied by the braking computers 16 into a command for each electromechanical actuator 13.

The braking computer 16 is designed to implement, for each of the wheels 4 of the main landing gear 3a, an anti-skid function. Implementation of this anti-skid function requires the estimating of the rotational speed of each wheel 4. This estimate of the rotational speed of the wheels 4 makes it possible to determine whether a wheel 4 which is turning is on the point of locking up, and to reduce the braking force commanded so that the wheel 4 continues to turn.

In the method of the invention for controlling braking, for a given wheel 4, implementation of the anti-skid function uses the measurements of the angular position of the rotor of the electric motor 6 associated with said wheel 4 in order to estimate the rotational speed of the wheel 4.

The position sensors 8 of each of the electric motors 6 of the wheels 4 of the main landing gear 3a are for this reason connected to the braking computer 16 associated with the wheels 4 of the main landing gear 3a. The rotational speed of each wheel 4 is obtained from the rotational speed of the associated rotor, taking the reduction ratio between the wheel 4 and the rotor into consideration. The rotational speed of the rotor, for its part, is obtained by simply deriving it from the angular position of the rotor, using the following formula:

$${Vrotor}_{n} = \frac{{θ}_{n} - {θ}_{n - 1}}{{t}_{n} - {t}_{n - 1}} ,$$

where Vrotorₙ is the rotational speed of the rotor at the time tₙ, θₙ is the angular position of the rotor at the time tₙ, and θₙ₋₁ is the angular position of the rotor at the time tₙ₋₁.

The invention is not restricted to the particular embodiment which has just been described but of course on the contrary covers any alternative form that falls within the scope of the invention as defined by the claims.

Although a specific and simplified design of the braking system and of the wheel rotational drive system have been used here to describe the invention, the method of the invention is of course applicable to any aircraft of which at least one braked wheel is associated with means of driving the rotation of the wheel, the said drive means comprising an electric motor fitted with a position sensor for sensing the position of the rotor of the motor.

Although it has been indicated that the sensor that senses the angular position of the rotor of the electric motor is a resolver, it is entirely possible to foresee equipping the motor with some other type of position sensor: Hall-effect sensor, etc.

Finally, the method of the invention can also be implemented on landing gears the wheels of which are equipped with hydraulic brakes.

1. Method for managing the braking of a wheel (4) of an aircraft (1) fitted with a brake (11), the aircraft comprising brake control means suited to implementing an anti-skid function of the wheel (4), requiring an estimate of a rotational speed of the wheel (4), the aircraft further comprising means of driving the wheel (4) including an electric motor (6) intended to drive the wheel (4) in rotation, the said electric motor (6) being fitted with a position sensor (8) intended to provide measurements of the angular position of a rotor of the motor (6), characterized in that the method comprises the step, for implementing the anti-skid function, of estimating the rotational speed of the wheel (4) from measurements of the angular position of the rotor which are supplied by the position sensor (8).

2. Braking method according to claim 1, in which the electric motor (6) is a synchronous permanent magnet electric motor.

3. Braking method according to claim 1, in which the position sensor (8) is a resolver.

4. Braking method according to claim 1, in which the position sensor (8) is a Hall-effect sensor.
